(19) United States
(12) Patent Application Publication
(10) Pub. No.: US 2010/0307946 A1
(43) Pub. Date: Dec. 9, 2010

(54) MEMBRANE HOLDER

(76) Inventor: Hendrik J. F. Berends, Nijverdal (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 12/739,115

(22) PCT Filed: Oct. 7, 2008
(86) PCT No.: PCT/NL08/00220

§ 371 Date: Aug. 25, 2010

(30) Foreign Application Priority Data
Nov. 1, 2007 (NL) 1034617

(51) Int. Cl. B01D 63/04

(52) U.S. Cl. 206/443; 29/428

(57) ABSTRACT

The invention relates to a membrane holder, comprising a number of cartridges for holding elongate filter membranes, which cartridges have a substantially V-shaped cross-section, wherein the cartridges are connected hingedly to each other in longitudinal direction at right angles to the cross-section. The invention further relates to a method for manufacturing a filter, comprising the steps of:—providing a number of cartridges of substantially V-shaped cross-section which are connected hingedly to each other in longitudinal direction at right angles to the cross-section;—filling the cartridges with filter membranes;—rolling up the cartridges to a cylindrical form;—pushing the rolled-up cartridges into a cylindrical tube.

The invention relates to a membrane holder for holding together a large number of elongate filter elements such that they can be introduced into a tube, after which the filter membranes are cast in synthetic resin.

EP-A-1 560 639, which is an earlier application of applicant, describes a system wherein cartridges are filled with elongate filter membranes, after which these cartridges are pushed one by one into the filter housing. The cartridge is here pushed onto a guide rail arranged on the inner side of the filter housing such that, after being pushed in, the cartridge can no longer change position and cannot impede the insertion of other cartridges.

This prior art system provides advantages in the automation of the manufacture of filters. However, insertion one by one into the filter housing requires the due precision.

It is now an object of the invention to provide a membrane holder which further simplifies automation of the manufacture of filters.

This object is achieved with a membrane holder comprising a number of cartridges for holding elongate filter membranes, which cartridges have a substantially V-shaped cross-section, wherein the cartridges are connected hingedly to each other in longitudinal direction at right angles to the cross-section.

The relative position of the cartridges is determined by the hinged connection of the cartridges to each other, whereby the different cartridges required for the manufacture of a filter can be handled as one whole. Owing to the V-shape and the hinged connection it is moreover possible to roll the cartridges to form a cylinder so that the cartridges can be pushed in one operation into a filter housing.

In one embodiment the cartridges are elongate. The generally flexible filter membranes can hereby be readily supported. However, if the filter membranes have a reasonable stiffness, it is also possible for the cartridges to have only a shorter length in order to properly hold together the bundles of filter membranes. It is however recommended that the length of the cartridges is substantially the same as the length of the elongate filter membranes. The filter membranes are hereby properly supported and the risk of damage to the filter membranes is limited.

In yet another embodiment of the membrane holder according to the invention the cartridges comprise a truncated wedge-shaped cross-section.

Hereby created in the centre of cartridges rolled up to form a cylinder is a cylindrical cavity which can for instance be used for passage of a tube.

In a further preferred embodiment of the membrane holder according to the invention each cartridge comprises an enclosing element for closing the open side of the cartridge in order to enclose the filter membranes in the cartridges. The enclosing element prevents the filter membranes falling out of the cartridges, for instance when they are being rolled up.

The enclosing element is preferably a film which extends over and connects the cartridges hingedly to each other. The advantage of a film is that it does not greatly hamper the liquid flow in a filter, and does not stand in the way of a good filtering action of the filter membranes. It is moreover an element which is easy to handle during manufacture and which can for instance be arranged on the cartridges by means of welding.

Another option is that the enclosing element is a bracket arranged on the cartridge.

The invention further comprises a method for manufacturing a filter, comprising the steps of:

providing a number of cartridges of substantially V-shaped cross-section which are connected hingedly to each other in longitudinal direction at right angles to the cross-section;

filling the cartridges with filter membranes;

rolling up the cartridges to a cylindrical form;

pushing the rolled-up cartridges into a cylindrical tube.

A preferred embodiment of the method according to the invention comprises the step of closing the open side of the cartridges in order to prevent the filter membranes falling out during rolling-up.

In a particular embodiment the cartridges are connected hingedly to each other by a film arranged on the cartridge, and the open side of the cartridges is also closed by the film. Separate cartridges of V-shaped cross-section can thus be used which are connected hingedly to each other by the film before they are rolled up.

Another embodiment of the method according to the invention comprises the step of providing a cylindrical guide, which has an inlet opening in longitudinal direction such that the cartridges can be fed successively into the cylindrical guide and can be rolled up lying against the wall to form a cylinder. Using this method the use of a closing element can be dispensed with. The closure is in fact provided by the cylindrical guide against which the cartridges are arranged. When the cartridges are rolled up to form a cylinder, they can be pushed from the cylindrical guide directly into a tube.

These and other features of the invention are further elucidated with reference to the accompanying drawings.

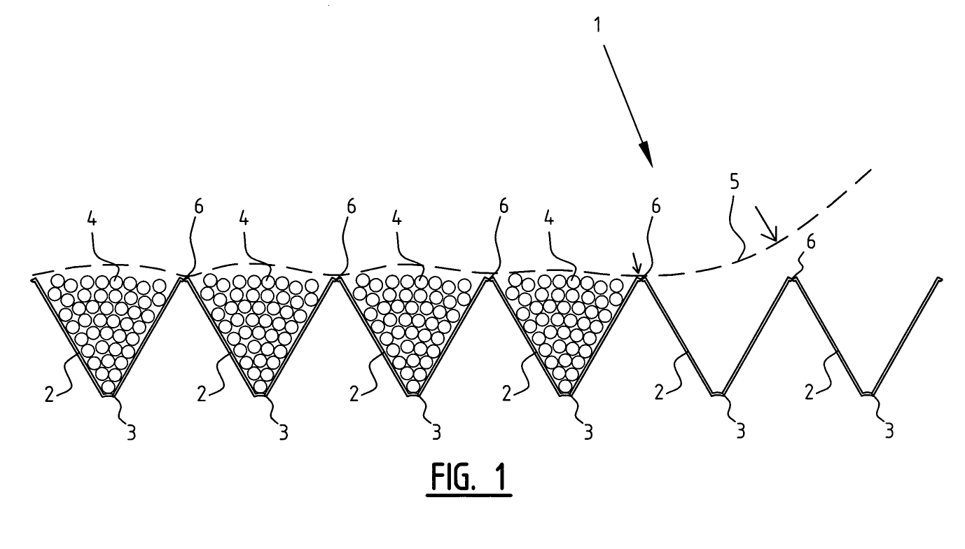

FIG. 1 shows a cross-section of a first embodiment of a membrane holder according to the invention.

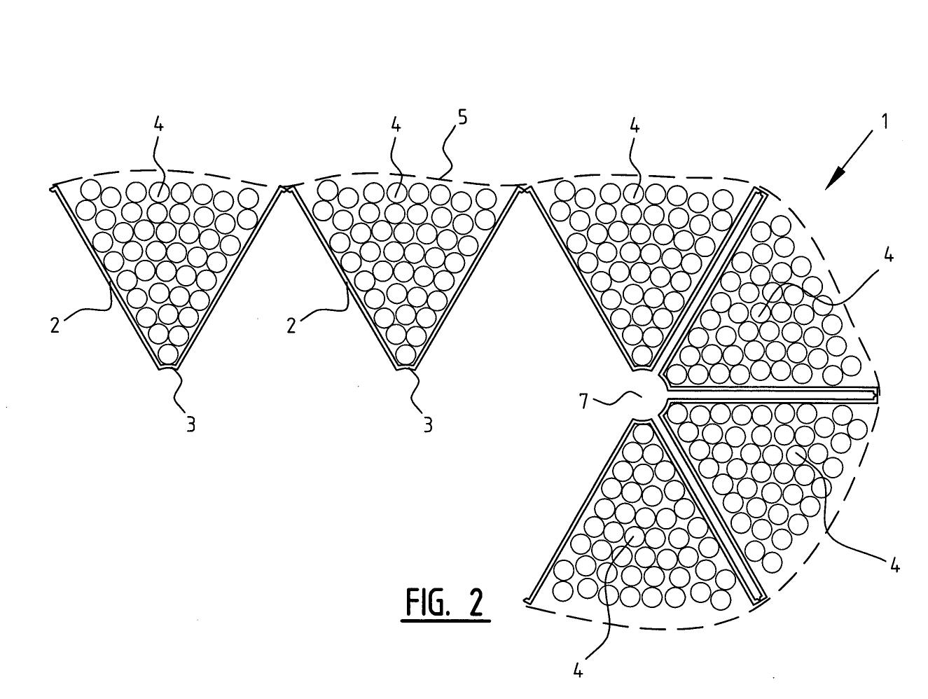

FIG. 2 shows how the membrane holder of FIG. 1 is rolled up.

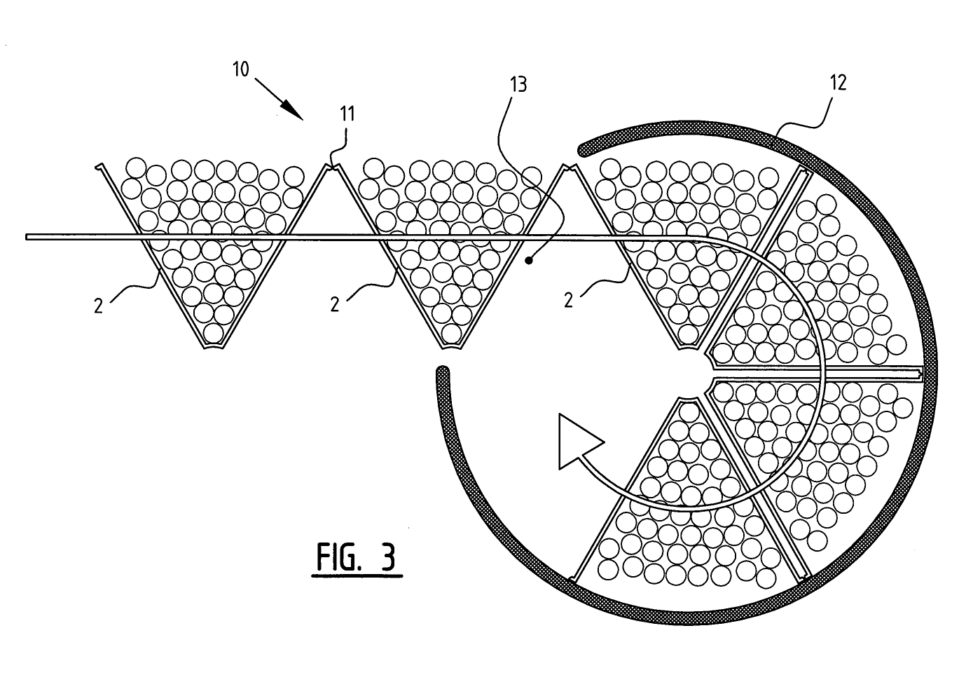

FIG. 3 shows a second embodiment of a membrane holder according to the invention and the manner in which it can be rolled into a cylindrical form.

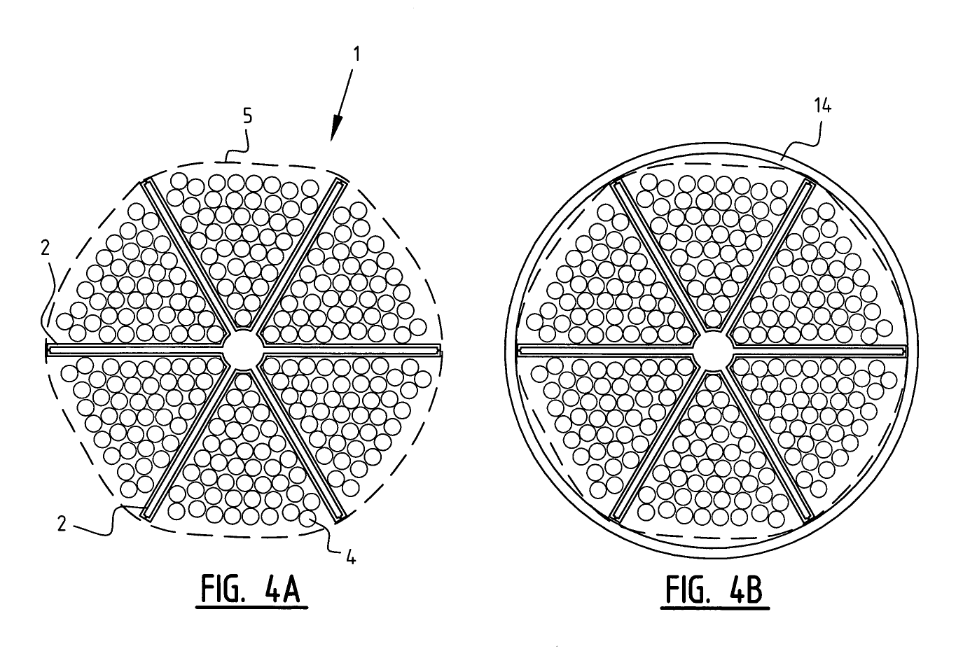

FIGS. 4A and 4B show the rolled-up membrane holder as according to FIG. 1.

FIG. 1 shows a membrane holder 1 in flat position. Membrane holder 1 consists of a number of cartridges 2 having a substantially V-shaped cross-section. The underside 3 is truncated, whereby a central passage is created in the rolled-up position. Filter membranes 4 are placed in cartridges 2.

A film 5 is then placed over cartridges 2 in order to prevent filter membranes 4 falling out of the cartridges.

Cartridges 2 are connected hingedly to each other at 6 by means of a linear hinge or by means of an arranged film 5.

In FIG. 2 a membrane holder 1 as according to FIG. 1 is rolled up. Due to the truncated underside 3 of cartridges 2, a central passage 7 is created in the cartridges 2 rolled up to form a cylinder.

FIG. 3 shows a second embodiment of a membrane holder 10. This membrane holder 10 likewise comprises cartridges 2 of a substantially V-shaped cross-section. These cartridges 2 are connected hingedly to each other by means of a linear hinge 11.

Provided for the purpose of rolling this membrane holder 10 into a cylindrical form is a cylindrical guide plate 12 which has an inlet opening 13 extending along the lengthwise direction and enabling the passage of a cartridge 2. The cartridges are then carried via inlet opening 13 into the cylindrical guide plate 12 such that cartridges 2 come to lie against the inner wall of guide plate 12 and can thus be rolled into a cylindrical form.

FIG. 4A further shows a cross-sectional view of membrane holder 1 in the rolled-up position. Film 5 here ensures that filter membranes 4 do not fall out of cartridges 2. In this rolled-up position as shown in FIG. 4A, membrane holder 1 can be pushed into a cylindrical filter housing 14 as shown in FIG. 4B. The filter can then be further finished by providing the two outer ends of filter housing 14 with a synthetic resin plug and further accessories in order to provide a membrane filter.

1. Membrane holder, comprising a number of cartridges for holding elongate filter membranes, which cartridges have a substantially V-shaped cross-section, wherein the cartridges are connected hingedly to each other in longitudinal direction at right angles to the cross-section.

2. Membrane holder as claimed in claim 1, wherein the cartridges are elongate.

3. Membrane holder as claimed in claim 2, wherein the length of the cartridges is substantially the same as the length of the elongate filter membranes.

4. Membrane holder as claimed in any of the foregoing claims, wherein the cartridges comprise a truncated wedge-shaped cross-section.

5. Membrane holder as claimed in any of the foregoing claims, wherein each cartridge comprises an enclosing element for closing the open side of the cartridge in order to enclose the filter membranes in the cartridges.

6. Membrane holder as claimed in claim 5, wherein the enclosing element is a film which extends over and connects the cartridges hingedly to each other.

7. Membrane holder as claimed in claim 5, wherein the enclosing element is a bracket arranged on the cartridge.

8. Method for manufacturing a filter, comprising the steps of:
providing a number of cartridges of substantially V-shaped cross-section which are connected hingedly to each other in longitudinal direction at right angles to the cross-section;
filling the cartridges with filter membranes;
rolling up the cartridges to a cylindrical form;
pushing the rolled-up cartridges into a cylindrical tube.

9. Method as claimed in claim 8, comprising the step of:
closing the open side of the cartridges in order to prevent the filter membranes falling out during rolling-up.

10. Method as claimed in claim 9, wherein the cartridges are connected hingedly to each other by a film arranged on the cartridge, and wherein the open side of the cartridges is also closed by the film.

11. Method as claimed in claim 10, wherein the film is arranged by welding.

12. Method as claimed in any of the claims 8-11, comprising the step of:
providing a cylindrical guide, which has an inlet opening in longitudinal direction such that the cartridges can be fed successively into the cylindrical guide and can be rolled up lying against the wall to form a cylinder.
